(19) United States
(12) Patent Application Publication
(10) Pub. No.: US 2025/0354858 A1
(43) Pub. Date: Nov. 20, 2025

(54) EFFICIENT METHODS FOR SOLVING CABLE DIVERSITY PUZZLES BY FIBER SENSING TECHNOLOGIES

(71) Applicant: NEC Laboratories America, Inc., Princeton, NJ (US)

(72) Inventors: Ming-Fang HUANG, Princeton, NJ (US); Ting WANG, West Windsor, NJ (US)

(73) Assignee: NEC Laboratories America, Inc., Princeton, NJ (US)

(21) Appl. No.: 19/208,561

(22) Filed: May 14, 2025

Related U.S. Application Data
(60) Provisional application No. 63/648,755, filed on May 17, 2024.

(51) Int. Cl. G01H 9/00; G01M 11/08

(52) U.S. Cl. CPC G01H 9/004; G01M 11/088

(57) ABSTRACT

Disclosed are systems and methods that analyze DFOS sensing data from different optical fibers located within the same cable, and discern how many of the different optical fibers are routed in different directions, their distances, or the circuits through which they pass. When combined with cable survey techniques, our systems and methods according to aspects of the present disclosure rapidly identify optical fiber cable diversity. Our inventive systems and methods according to aspects of the present disclosure employ a route condition matched engine and interactive feedback between field technicians and DFOS systems. These aspects are coupled with interactive-AI-based algorithms to solve what we have called, a cable diversity puzzle quickly, with minimum field efforts.

### CROSS REFERENCE TO RELATED APPLICATIONS

This application claims the benefit of U.S. Provisional Patent Application Ser. No. 63/648,755 filed May 17, 2024, the entire contents of each of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Temperature Sensing (DTS) systems and methods that measure soil moisture and water seepage in soil and earthen embankments respectively.

### BACKGROUND OF THE INVENTION

As those skilled in the art will understand and appreciate, telecommunications service providers, carriers and owners have extensively deployed optical fiber cables for communication purposes. Typically, these optical fiber cables contain tens or hundreds of individual optical fibers. As these optical fibers traverse various circuits, they diverge in different directions, even if they originated from a same circuit.

In instances where optical fiber cables are older, or are underground, optical fiber layout maps used for maintenance of the optical fiber cables can be complicated. More particularly, after a passage of time, the optical fiber layout maps may be missing or out-of-date. When combined with a lack of historical, institutional knowledge about actual optical fiber layouts, operators of the optical fiber cables are challenged when attempting to locate and/or identify precise optical fiber routes. Consequently, resolving this “optical fiber diversity puzzle” is of paramount interest for telecommunications carriers and optical fiber cable owners to efficiently manage and maintain their optical fiber facilities.

Presently, there are no optimal solutions for discovering fiber diversity. Field technicians often rely on paper records, individual experience, or memory to locate specific fibers after passing through several circuits or maintenance. Another method involves disconnecting the fiber and checking it at each circuit, which is an inefficient process

### SUMMARY OF THE INVENTION

An advance in the art is made according to aspects of the present disclosure directed to systems and methods that employ distributed fiber optic sensing (DFOS)/distributed vibration sensing (DVS) in conjunction with generative AI-based algorithms.

In sharp contrast to the prior art, our inventive systems and methods according to aspects of the present disclosure analyze DVS sensing data from different optical fibers located within the same cable, and discern how many of the different optical fibers are routed in different directions, their distances, or the circuits through which they pass. When combined with cable survey techniques, our systems and methods according to aspects of the present disclosure rapidly identify optical fiber cable diversity.

As those skilled in the art will understand and appreciate, our inventive systems and methods according to aspects of the present disclosure employ a route condition matched engine and interactive feedback between field technicians and DFOS systems. These aspects are coupled with interactive-AI-based algorithms to solve what we have called, a cable diversity puzzle quickly, with minimum field efforts.

Advantages of our inventive systems and methods include at least the following.

### Quick Response

Distributed fiber optic sensing technology provides real-time response of cable route conditions. Even after swapping 16 fibers, DFOS is able to identify which fibers are routed to the same destination, and which fibers are routed to different destinations.

### Precise Location Data

Distributed fiber optic sensing advantageously pinpoints an exact location of a fiber split, consequently technicians only need visit fiber splitting locations and utilize Cable ID product to identify different fiber route directions—thereby facilitating quicker and accurate route directions.

### Wide Coverage

Distributed fiber optic sensing provides wide coverage along an entire DFOS sensor cable length, ensuring that no section is left uninspected.

### Scalability

Distributed fiber optic sensing technology is scalable such that it may monitor multiple fiber optic cables or an entire fiber optic network, making it suitable for various infrastructure sizes

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing features and operational details of an illustrative system according to aspects of the present disclosure.

FIG. 3 is a schematic diagram showing illustrative fiber optic cable connected to DFOS system and multiple nodes according to aspects of the present disclosure.

FIG. 4 is a schematic diagram showing illustrative features in hierarchical format of systems and methods according to aspects of the present disclosure.

FIG. 5 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

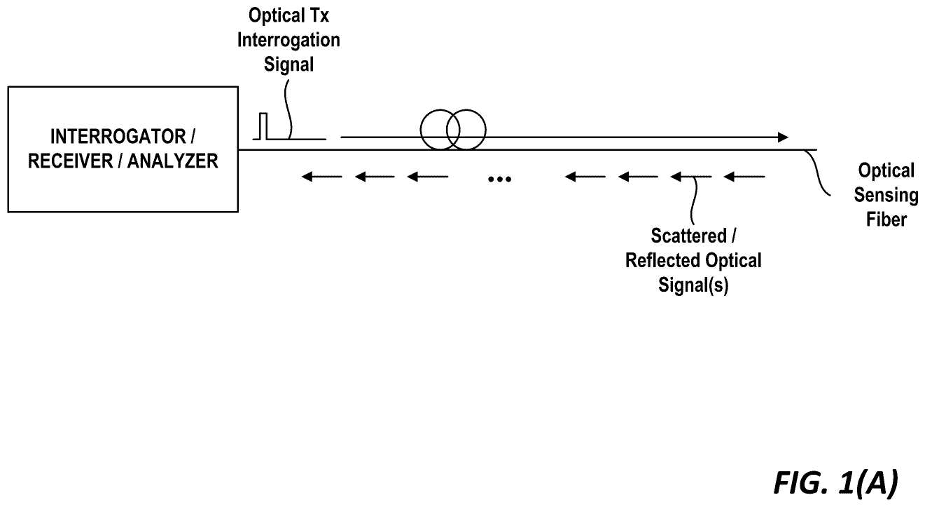

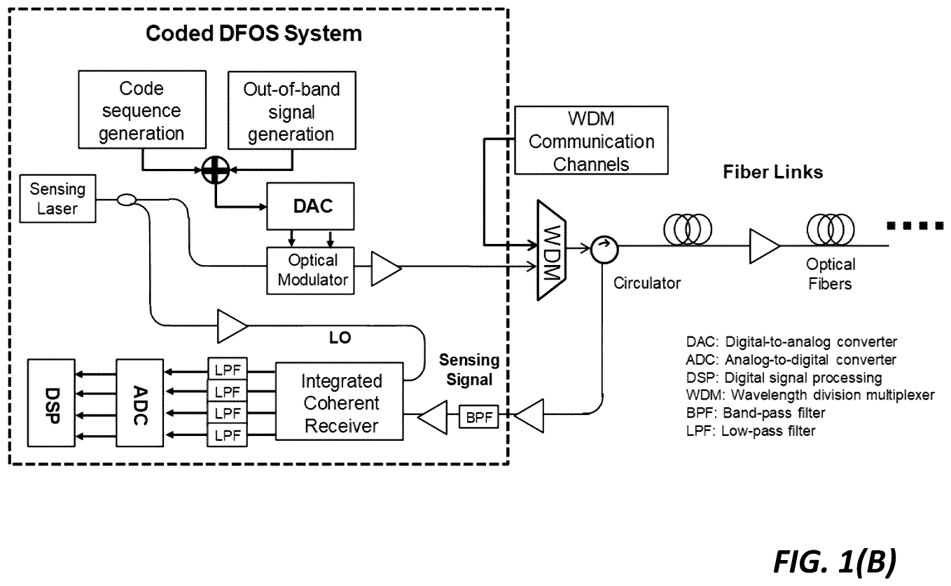

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

As we have noted, key features and advantages of DFOS and DVS in particular include at least the following.
Continuous Monitoring: Provides a temperature profile along the entire length of the fiber, offering much more information than discrete sensors.
Long Distances: Can monitor temperatures over distances of many kilometers (up to 100 km or more with some systems).
High Spatial Resolution: Can achieve temperature measurements with a spatial resolution down to one meter or even better in some specialized systems.
Immunity to Electromagnetic Interference (EMI): Optical fibers are immune to EMI, making DTS suitable for industrial environments with electrical noise.
Safety in Hazardous Environments: Low laser power levels used in many DTS systems make them safe for use in potentially explosive atmospheres.
Cost-Effective for Large Areas/Distances: Reduces the need for numerous individual sensors and their associated wiring and installation costs.
Versatile Applications: Used in a wide range of industries for various monitoring tasks.

Accordingly, and as will be readily understood and appreciated by those skilled in the art, distributed vibration sensing is a powerful technology that leverages the properties of optical fibers and light scattering to provide continuous and spatially resolved vibration measurements over long distances, offering significant advantages for a wide array of monitoring applications.

As we have previously noted, there exist no optimal solutions for discovering optical fiber diversity. Field technicians often rely on paper records, individual experience, or memory to locate specific fibers after passing through several circuits or maintenance. Another method involves disconnecting the fiber and checking it at each circuit, which is an inefficient process.

An advance in the art is made according to aspects of the present disclosure directed to systems and methods that employ distributed fiber optic sensing (DFOS)/distributed vibration sensing (DVS) in conjunction with generative AI-based algorithms.

In sharp contrast to the prior art, our inventive systems and methods according to aspects of the present disclosure analyze DVS sensing data from different optical fibers located within the same cable and discern how many of the different optical fibers are routed in different directions, their distances, or the circuits through which they pass. When combined with cable survey techniques, our systems and methods according to aspects of the present disclosure rapidly identify optical fiber cable diversity.

As those skilled in the art will understand and appreciate, our inventive systems and methods according to aspects of the present disclosure employ a route condition matched engine and interactive feedback between field technicians and DFOS systems. These aspects are coupled with interactive-AI-based algorithms to solve what we have called, a cable diversity puzzle quickly, with minimum field efforts.

Advantages of our inventive systems and methods include at least the following.

### Quick Response

Distributed fiber optic sensing technology provides real-time response of cable route conditions. Even after swapping 16 fibers, DFOS is able to identify which fibers are routed to the same destination, and which fibers are routed to different destinations.

### Precise Location Data

Distributed fiber optic sensing advantageously pinpoints an exact location of a fiber split, consequently technicians only need visit fiber splitting locations and utilize Cable ID product to identify different fiber route directions—thereby facilitating quicker and accurate route directions.

### Wide Coverage

Distributed fiber optic sensing provides wide coverage along an entire DFOS sensor cable length, ensuring that no section is left uninspected.

### Scalability

Distributed fiber optic sensing technology is scalable such that it may monitor multiple fiber optic cables or an entire fiber optic network, making it suitable for various infrastructure sizes

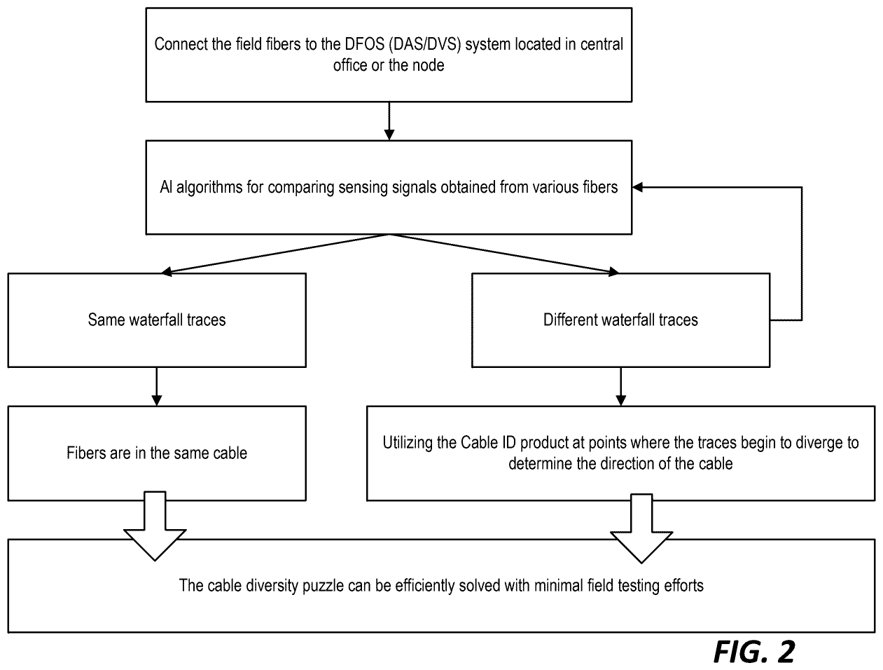

FIG. 2 is a schematic diagram showing features and operational details of an illustrative system according to aspects of the present disclosure.

As outlined in FIG. 2, field fibers are connected to a DFOS (Distributed Acoustic Sensing (DAS)/Distributed Vibration Sensing (DVS)) system that may be located in a central office. Artificial Intelligence algorithms for comparing the sensing signals from various optical fibers are utilized to analyze the signals and when the different fibers exhibit the same waterfall traces, the fibers are determined to be in the same cable. When the different fibers exhibit different waterfall traces, a further analysis is performed to determine where the waterfall traces begin to diverge to determine the directions of the fibers and hence, the cable. As a result, the cable diversity issues noted previously are conveniently solved.

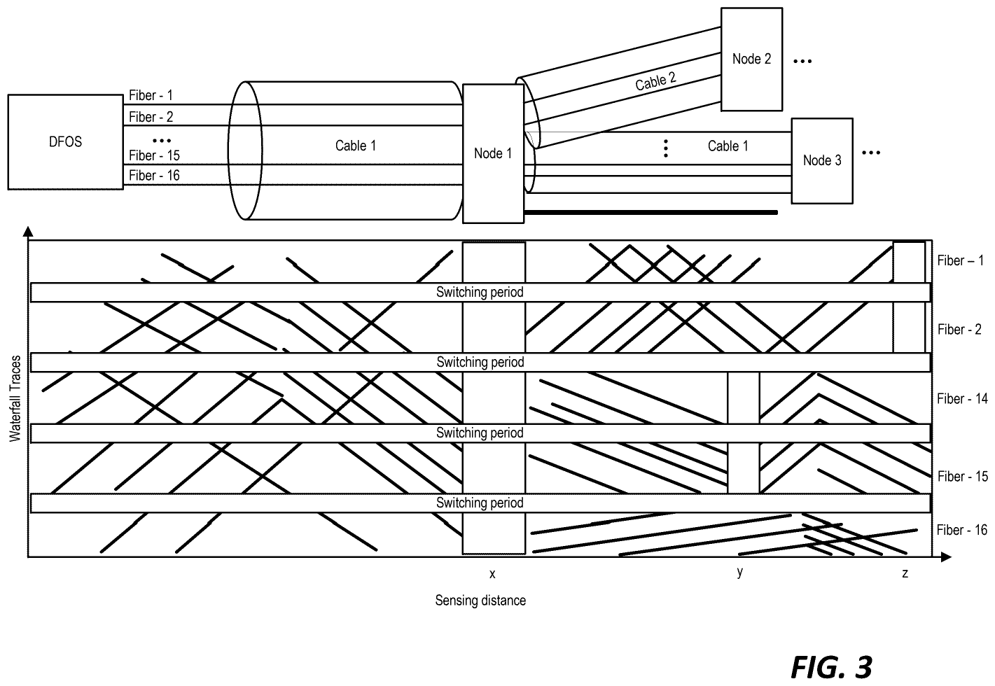

FIG. 3 is a schematic diagram showing illustrative fiber optic cable connected to DFOS system and multiple nodes according to aspects of the present disclosure. With reference to that figure, an overall procedural operation may be referenced.

### Step 1: Setup and Connection

Connect the fibers undergoing testing to the DFOS system, situated either in the central office or at a remote terminal. The DFOS systems can be either DAS or DVS. As depicted in FIG. 3, 16 fibers within the same cable are linked to 16 ports on the DFOS.

### Step 2: Received Sensing Signals

As depicted in FIG. 3, the received sensing signals are presented in the waterfall plots. With an automatic switching function, the signals rotate and swap from Fiber-1 to Fiber-16. Users can define the switching period and detection period. Typically, switching periods are set at 60 seconds for detection and 5 seconds for switching.

### Step 3: AI Assessment of Fiber Change Direction Points

Utilizing the waterfall traces, the AI engine establishes continuous correlations between fibers under test, accurately identifying change points and their corresponding fibers. Continued reference to FIG. 3 as the example:

Step 3-0:

The detected trajectories extend continuously from 0 meters to x meters between Fiber-1 to Fiber-16. This high degree of continuous correlation between Fiber-1 and Fiber-16 confirms they are within the same cable and direction.

Step 3-1: Beyond the x meters mark, the continuous correlation between fibers diminishes, confirming that the first fiber changing direction point is located at x meters

Step 3-2: The continuous correlation between Fiber-1 and Fiber-2 is strong, while it is not as pronounced with others. Similarly, the continuous correlation between Fiber-14 and Fiber-15 is significant, but not with others. However, the continuous correlation of Fiber-16 with others is low. These observations confirm that Fiber-1 and Fiber-2 are in the same direction, Fiber-14 and Fiber-15 are in the same direction, and Fiber-16 is in a different direction.

### Step 4: Field Survey

Rather than surveying all 16 fibers, only the change point (e.g., node 1 at x meters) and fiber directions following splits need to be determined using NEC Cable Positioning Locator features in the FOSS product.

### Step 5: Solving the Puzzle of Cable Diversity

Following AI assessment for fiber change direction points and field survey of these points and fiber directions post-splits, determining the fiber directions for the 16 fibers under test can be achieved with minimal field efforts. As will be understood and appreciated by those skilled in the art, this process enables the resolution of the cable diversity puzzle

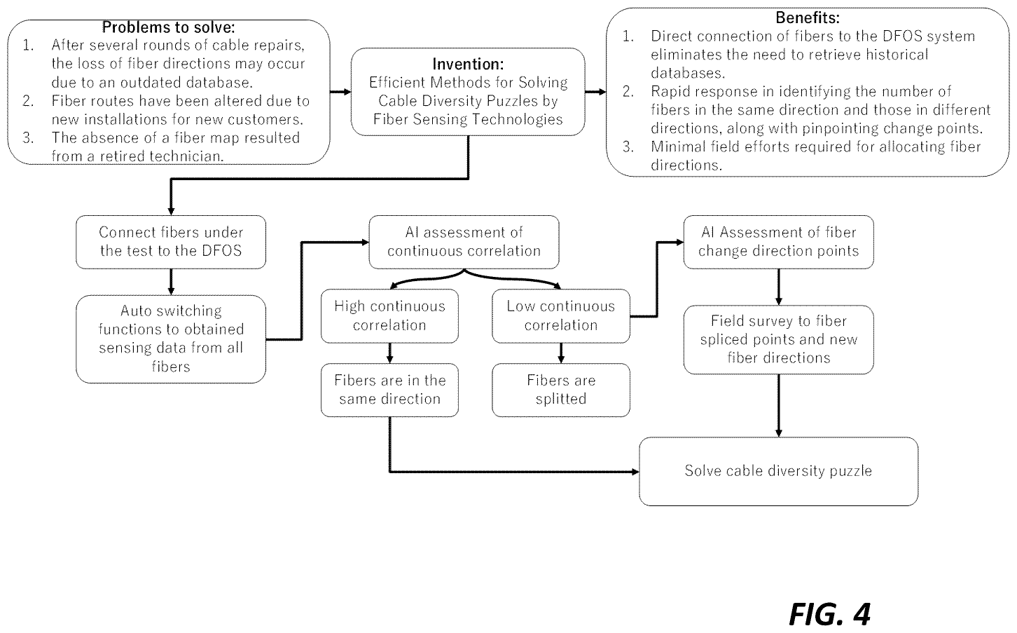

FIG. 4 is a schematic diagram showing illustrative features in hierarchical format of systems and methods according to aspects of the present disclosure.

With reference to FIG. 4, it may be understood that our inventive systems and methods according to aspects of the present disclosure solve the problems associated with determining the connectivity and directions of optical fiber cables that have been deployed and the fiber routes and/or fiber maps are out of date, not adequately documented, or understood with respect to their connectivity.

As illustratively described, using DFOS, the fibers are connected to a DFOS system and sensing data is obtained from optical fibers in the optical fiber cables. In instances where a continuous correlation is made, the fibers are determined to be in the same direction as one another. Where there exist a low continuous correlation, the fibers are split from one another. In such instance, an AI assessment of fiber change direction points is made and new determinations of fiber splice points to fiber directions are made and documented.

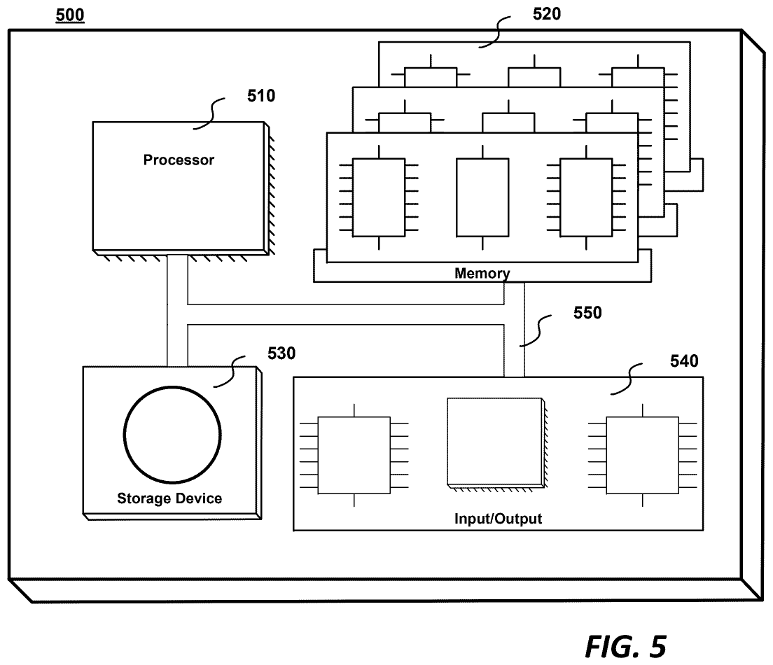

FIG. 5 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 500 as stored program control instructions.

Computer system 500 includes processor 510, memory 520, storage device 530, and input/output structure 540. One or more input/output devices may include a display 545. One or more busses 550 typically interconnect the components, 510, 520, 530, and 540. Processor 510 may be a single or multi core. Additionally, the system may include accelerators etc., further comprising the system on a chip.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations for system 500.

While we have presented our inventive concepts and description using specific examples, our invention is not so limited. Accordingly, the scope of our invention should be considered in view of the following claims.

1. A computer-implemented method for determining optical fiber diversity in an optical fiber cable having a plurality of individual optical fibers, the method comprising:
by the computer:
collecting distributed fiber optic sensing (DFOS) data from a plurality of the individual optical fibers;
comparing waterfall traces of the DFOS data for the plurality of individual optical fibers;
determining, from the comparison of the waterfall traces, whether the individual optical fibers are included in a same optical fiber cable.

2. The method of claim 1 wherein a DFOS system automatically switches among the plurality of individual optical fibers while collecting the DFOS data.

3. The method of claim 2 wherein a switching period defining the rate at which the DFOS automatically switches is set by a user of the DFOS system.

4. The method of claim 3 further comprising establishing, by an artificial intelligence (AI) engine, continuous correlations between the individual optical fibers.

5. The method of claim 4 further comprising identifying change points and their corresponding fibers.
